(19) United States
(12) Patent Application Publication
(10) Pub. No.: US 2010/0326904 A1
(43) Pub. Date: Dec. 30, 2010

(54) WASTEWATER TREATMENT

(75) Inventor: Garfield R. Lord, Providenciales (TC)

Correspondence Address: DARBY & DARBY P.C., P.O. BOX 770, Church Street Station, New York, NY, 10008-0770, US

(73) Assignee: BIONEST TECHNOLOGIES INC., Grand-Mere (CA)

(21) Appl. No.: 12/678,240

(22) PCT Filed: Sep. 12, 2008
(86) PCT No.: PCT/CA08/01624

§ 371 Date: Sep. 9, 2010

Related U.S. Application Data
(60) Provisional application No. 60/972,424, filed on Sep. 14, 2007.

(51) Int. Cl. C02F 9/14; C02F 3/28; C02F 3/02

(52) U.S. Cl. 210/605; 210/170.08; 210/150; 210/151

(57) ABSTRACT

A system for treating wastewater, the system including: a septic tank for separating solid matter from liquid matter in raw wastewater; a bioreactor for receiving and biologically treating the liquid raw wastewater from the septic tank to lower its biochemical oxygen demand; and a de-oxygenating reactor for receiving and further treating the biologically treated wastewater from the bioreactor to reduce dissolved oxygen levels in the biologically treated wastewater; wherein the system is arranged so that at least a portion of the wastewater treated in the de-oxygenating reactor flows back into the septic tank and the bioreactor before being discharged from the system.

### FIELD OF THE INVENTION

The present invention generally relates to a system, an apparatus and a method for treating wastewater.

### BACKGROUND OF THE INVENTION

Wastewater can include the discharges from residential and/or commercial as well as industrial waste and/or wastewater tanks, such as sewage or industrial effluent. Wastewater also includes “black water” from toilets and “grey water” from showers, sinks, washing machines and the like. Septic wastewater will often have a high biochemical oxygen demand (BOD) due to organic (carbonaceous) matter and high levels of nitrogen both in its reduced and oxidized forms.

There are many known systems and methods for treating and purifying wastewater and these generally involve the removal of solid and organic matter from the wastewater. The solids can be separated from the liquid component of wastewater in a settling or septic tank and/or using a filter. Organic matter is typically removed by breakdown by microorganisms such as bacteria in a bioreactor in which the growth of microorganisms are promoted, for example by aerating the wastewater in the bioreactor. During aeration, a portion of the carbonaceous matter in the wastewater is oxidized to carbon dioxide, which can diffuse out of the wastewater. Also during aeration, nitrogen-containing compounds, such as ammonia, are converted to nitrates in a process known as nitrification. This results in a lowering of the BOD and the resultant treated wastewater is either discharged into a water supply or to the environment.

However, the resultant treated wastewater can contain high levels of nitrates. There is growing concern about the release of nitrates into the environment both in terms of their impact on the environment and their harmful effect on humans through contaminated drinking water. Accordingly, a denitrification step is often incorporated into known wastewater treatment systems to remove nitrogen. Denitrification typically involves treatment with anaerobic microorganisms in the absence of oxygen. During denitrification, nitrate ions are converted to nitrogen gas, which can diffuse out of the water. Since carbon is removed in the nitrification step, supplemental carbon often needs to be added during denitrification, as carbon is required by the denitrifying bacteria for the denitrification process. However, in the cases where additional carbon is added to the system for denitrification, excess carbon may remain in the treated wastewater, which can lead to high BOD levels, which is itself considered to be a pollutant. Therefore, the supplemental carbon added during denitrification must often be carefully measured and balanced so that there is enough carbon for effective denitrification but not too much to increase BOD levels in the treated wastewater.

In U.S. Pat. No. 5,342,522, a wastewater treatment system is described where carbon and nitrogen removal occurs in a first step, followed by nitrification in a second step, and denitrification in a third step. In the denitrification step, additional carbon is provided which may be an external organic carbon or the sludge from the first step. This approach requires perfect matching of added carbon and nitrate otherwise the effluent will contain high levels of carbon or nitrate.

U.S. Pat. No. 5,676,828 describes an anaerobic ammonification and denitrification reactor into which wastewater is fed and from which treated wastewater is discharged as effluent, and an aerobic nitrification reactor which treats water from the ammonification and denitrification reactor which is then recycled back in to the ammonification and denitrification reactor. In this system, the carbon that is already present in the wastewater is used as the organic carbon for denitrification.

An object of the present invention is to provide an improved system, apparatus and method of wastewater treatment, which avoids or minimizes the disadvantages of existing wastewater treatment systems, apparatus and methods as outlined above.

### SUMMARY OF THE INVENTION

The Applicants have made the surprising discovery that in many aerobic wastewater treatment processes which achieve low levels of BOD and nitrification by the use of aeration, there remains a high level of dissolved oxygen in the effluent from the aerobic treatment processes which can be in the 3 to 5 mg/L range. When the treatment process involves recycling a portion of this effluent back to a septic tank to contact an organic carbon source for denitrification, this dissolved oxygen can increase the oxygen levels in the septic tank so that denitrification is inhibited. Therefore, the Applicants' novel approach is to reduce or eliminate the dissolved oxygen in the recycled effluent before denitrification. The Applicants made the surprising discovery that substances having a biochemical oxygen demand have the effect of substantially de-oxygenating the wastewater to create substantially anoxic conditions for denitrification of the wastewater to occur.

Broadly, the present invention provides a system, apparatus and method for improving denitrification efficiency in wastewater treatment by reducing or eliminating dissolved oxygen in the wastewater to be denitrified. Therefore, the present invention reduces the difficulties and disadvantages of the aforesaid designs by providing an improved wastewater treatment system, apparatus and method, which reduces both nitrate and BOD levels in the wastewater being treated.

From one aspect, there is provided a system for treating wastewater, the system including: a septic tank for separating solid matter from liquid matter in raw wastewater; a bioreactor for receiving and biologically treating the liquid raw wastewater from the septic tank to lower its biochemical oxygen demand; and a de-oxygenating reactor for receiving and further treating the biologically treated wastewater from the bioreactor to reduce dissolved oxygen levels in the biologically treated wastewater; wherein the system is arranged so that at least a portion of the wastewater treated in the de-oxygenating reactor flows back into the septic tank and the bioreactor before being discharged from the system.

In one embodiment of the system, all of the treated wastewater from the de-oxygenating reactor flows into the septic tank and the treated wastewater is discharged from the system via the bioreactor.

In another embodiment of the system, one portion of the treated wastewater flows back into the septic tank from the de-oxygenating reactor and another portion of the treated wastewater is discharged from the system via the de-oxygenating reactor.

In both embodiments, the de-oxygenating reactor includes a substance having an oxygen demand to lower the levels of dissolved oxygen in the wastewater contained therein. The substance can be a substance which supports aerobic microorganisms such as organic carbon, wood, woodchips, sawdust, peat moss, straw, or seaweed.

The de-oxygenating reactor includes an inlet for receiving the biologically treated wastewater from the bioreactor and an outlet for re-circulating the treated wastewater to the septic tank, the substance being positioned between the inlet and the outlet such that wastewater flowing from the inlet to the outlet will contact the substance. Preferably, the outlet is positioned above the inlet such that the treated wastewater must percolate through the substance, which is preferably woodchips or wood shavings, between the inlet and the outlet before being discharged from the de-oxygenating reactor. It will be understood that the outlet is positioned above the discharge point of the inlet. Alternatively, the inlet can be positioned above the outlet i.e. a discharge point of the outlet.

The de-oxygenating reactor can include a filter, such as a geotextile or the like, to avoid clogging of the inlet or the outlet. Either one or both of the inlet and the outlet can comprise an elongate member having openings formed therein.

The system may further comprise an unsupported bacteria growth device in the septic tank or the bioreactor, the unsupported bacteria growth device comprising at least one strip loosely bundled up in an unbound, nest-like configuration, the strip having surfaces for bacteria to attach and grow on. Incorporating such a bacteria growth device within embodiments of the present system enables a greater volume of nitrification/denitrification when compared to what is possible in the majority of systems, apparatuses and methods known in the art. For example, the large surface area to volume ratio of the bacteria growth device enables the reduction of the toxic concentrations of ammonia/nitrite/nitrate very rapidly. Moreover, per meter squared, the bacteria growth device provides one of the less costly water treatment devices on the market. When used with the system of the present invention, its high productivity translates into a greater infiltration for a smaller volume. Thus, the present system is a low cost solution for any type of wastewater treatment application, whether residential or commercial.

Advantageously, the de-oxygenating reactor reduces the dissolved oxygen in the recirculation loop before sending a part or whole of the treated water to the septic tank where denitrification can occur and then to the bioreactor where the BOD levels can be reduced. Therefore, the de-oxygenating reactor has a synergistic effect with the septic tank and bioreactor.

Advantages of the present system, both with and without the bacteria growth device, include being able to decrease the size of the septic tank and the bioreactor (the casing of the reactor can be of a dimension similar to that of the septic tank); being able to perform the flow of the wastewater through the system mainly by gravity; treating the wastewater independently of soil conditions; it can act as a secondary treatment system which ejects a quality effluent enabling the maintenance of a healthy environment; the materials used with the bacteria growth device are non-biodegradable and thus require no replacement over time; and the reactor can be installed underground and so does not modify at all the appearance of the land. The system can reduce in size or replace a leaching field or bed and can be sized according to the amount of wastewater produced by the septic tank or community effluent discharge as well as its specific biological or biochemical oxygen demand (BOD). Water thus treated is decontaminated to a quality level that allows for its discharge either into the ground or surface discharge for irrigation by meeting national and local requirements.

From another aspect, there is provided an apparatus for use in a wastewater treatment system, the apparatus having a chamber for receiving wastewater to be treated, the chamber including a substance having an oxygen demand to reduce the amount of oxygen dissolved in the wastewater to allow denitrification of the wastewater to occur. The substance can be a substance which can support aerobic organisms such as organic carbon, wood, woodchips, sawdust, peat moss, straw, or seaweed.

The apparatus further comprises an inlet for receiving the wastewater and an outlet for discharging the treated wastewater, the substance being positioned between the inlet and the outlet such that wastewater flowing from the inlet to the outlet will contact the substance. Advantageously, the outlet can be positioned above the inlet i.e. a discharge point of the inlet, such that the wastewater must percolate through the substance between the inlet and the outlet before being discharged from the apparatus. Alternatively, the inlet can be positioned above the outlet i.e. a discharge point of the outlet. There may also be provided a filter, such as a geotextile or the like, to avoid clogging of the inlet or the outlet. Either one or both of the inlet and the outlet can comprise an elongate member having openings formed therein.

The outlet can be in fluid communication with a second chamber where denitrification takes place, and the second chamber can be in fluid communication with a third chamber for lowering biochemical oxygen demand levels. The apparatus may further comprise an unsupported bacteria growth device, the unsupported bacteria growth device comprising at least one strip loosely bundled up in an unbound, nest-like configuration, the strip having surfaces for bacteria to attach and grow on.

Advantageously, the apparatus can be incorporated into most known wastewater treatment systems of the prior art that have a recirculation loop back to the septic tank for example, for example the wastewater treatment system described in the Applicants' WO 03/027031, the contents of which are incorporated herein in their entirety, to reduce dissolved oxygen levels in the wastewater.

According to a yet further aspect of the invention, there is provided a method for treating wastewater, the method comprising: a) separating solid and liquid matter from raw wastewater in a septic tank; b) biologically treating the liquid matter in a bioreactor to lower biochemical oxygen demand levels of the liquid matter; c) treating the biologically treated liquid matter in a de-oxygenating reactor to reduce levels of dissolved oxygen to allow for denitrification to occur; and d) re-cycling at least a portion of the biologically treated liquid matter from the de-oxygenating reactor through the septic tank and the bioreactor before discharging from the system.

In one embodiment, all of the treated wastewater from the de-oxygenating reactor is re-cycled through the septic tank and is discharged from the bioreactor.

In another embodiment, one portion of the treated wastewater from the de-oxygenating reactor is re-cycled through the septic tank, and another portion of the treated wastewater is discharged from the de-oxygenating reactor. In this case, the method may further comprise pumping the portion of the treated wastewater from the de-oxygenating reactor to the septic tank.

In both embodiments, treating the biologically treated liquid matter in the de-oxygenating reactor to reduce levels of dissolved oxygen comprises contacting the biologically treated liquid matter with a substance having an oxygen demand. Preferably, the substance comprises woodchips and the biologically treated liquid matter flows through the woodchips. The substance can be any substance which reduces levels of dissolved oxygen such as a substance which can support aerobic organisms.

According to yet a further aspect, the method comprises reducing or eliminating dissolved oxygen in treated wastewater so that denitrification of the treated wastewater can take place or occur more efficiently. Preferably, the dissolved oxygen in the wastewater is reduced or eliminated by exposing or contacting the wastewater with a BOD source. Preferably, the subsequent step occurs in a septic tank and wherein the method includes a further step of biologically treating effluent from the septic tank to lower the level of biochemical oxygen demand in the wastewater before discharging the treated wastewater.

All aspects of the present invention provide a step forward with respect to the protection of the environment and the battle against the contamination of water resources by transforming wastewater into cleaned and purified water of superior quality. The present invention is also advantageous in that it may be used in various technical fields of nitrification/denitrification, namely in sewage treatment, aquaculture, aquariums and ponds, water processing, wastewater remediation, and the like.

All aspects of the invention described herein are an improvement of the devices and systems of the prior art, in that they have the following advantages: the discharged effluent is of exceptional quality; the system is compact, efficient, and easy-to install; the system is generally passive; the maintenance is minimal, given the fact that it consists of a generally passive system, which may be almost entirely activated by gravity; the system may be permanently installed as replacement of parts is not required; the energy costs to run the system and the method are minimal; capability to monitor at a distance; considerable reduction of the surface of the purification field; removal of 99% of E. Coli bacteria before the effluent reaches the soil; efficient in all seasons independent of weather conditions; possible use of the effluent for irrigation purposes following disinfection by an additional ozone or sterilizing UV-ray treatment , tablet chlorination or the like.

### BRIEF DESCRIPTION OF THE DRAWINGS

In order that the invention may be more readily understood, currently preferred embodiments will now be further described by way of example only with reference to the accompanying drawings in which:

FIG. 1 is schematic illustration of a wastewater treatment system, including a septic tank, a bioreactor and a de-oxygenating reactor, according to one embodiment of the present invention;

FIG. 2 is a schematic plan view of the wastewater treatment system of FIG. 1;

FIG. 3 is a schematic cross-sectional view of the wastewater treatment system of FIG. 1;

FIG. 4(a) is a schematic plan view of the de-oxygenating reactor of FIG. 1;

FIG. 4(b) is a schematic cross-sectional view of the de-oxygenating reactor of FIG. 1;

FIG. 5 is a schematic illustration of a wastewater treatment system, including a septic tank, a bioreactor and a de-oxygenating reactor, according to another embodiment of the present invention;

FIG. 6 is a schematic plan view of the wastewater treatment system of FIG. 5;

FIG. 7 is a schematic cross-sectional view of the wastewater treatment system of FIG. 5;

FIG. 8 is a schematic representation of a bacteria growth device for use in the septic tank and/or bioreactor of any of FIGS. 1 to 3, and 5 to 7, the device having at least one strip intertwined into a nest-like configuration;

FIG. 9 is a plan view of a portion of a surface of the strip of FIG. 8 according to one embodiment;

FIG. 10 is a plan view of a portion of the surface of the strip of FIG. 8 according to another embodiment;

FIG. 11 is a plan view of a portion of the surface of the strip of FIG. 8 according to yet another embodiment;

FIG. 12 is a plan view of a portion of the surface of the strip of FIG. 8 according to yet a further embodiment;

FIG. 13 is a graph of apparent color of water at an inlet and an outlet of a bioreactor of a comparative system to the system of embodiments of the present invention;

FIG. 14 is a graph of levels of suspended solids at an inlet and an outlet of a bioreactor of a comparative system to the system of embodiments of the present invention;

FIG. 15 is a graph of levels of stercoraceous coliforms at an inlet and an outlet of a bioreactor of a comparative system to the system of embodiments of the present invention;

FIG. 16 is a graph of levels of BOD 5 days at an inlet and an outlet of a bioreactor of a comparative system to the system of embodiments of the present invention; and

FIG. 17 is a graph of levels of turbidity at an inlet and an outlet of a bioreactor of a comparative system to the system of embodiments of the present invention;

### DETAILED DESCRIPTION OF THE INVENTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items.

Furthermore, although the present invention was primarily designed for treating wastewater discharged from a residential, commercial or community wastewater system, it may be used for treating any liquid containing impurities in the present or in any other technical fields, such as industrial wastewater. For this reason, expressions such as “waste”, “water”, “septic” and the like should not be taken to limit the scope of the present invention and should be taken to include all other kinds of liquids or technical applications with which the present invention may be used and could be useful.

Moreover, in the context of the present invention, the expressions “water”, “liquid”, “effluent”, “discharge”, and any other equivalent expression known in the art used to designate a substance displaying liquid-like features, as well as any other equivalent expressions and/or compound words thereof, may be used interchangeably. Furthermore, expressions such as “polluted”, “contaminated” and “soiled “for example, may also be used interchangeably in the context of the present description. The same applies for any other mutually equivalent expressions such as “septic” and “settling”, as well as “reactor”, “assembly” and “clarifier” for example, as will be apparent to a person skilled in the art.

In addition, although an embodiment of the present invention as illustrated in the accompanying drawings comprises various components, such as small air and recirculation pumps, air diffusers, return lines, etc., and although the embodiment of the present invention as shown consists of certain geometrical configurations and arrangements, not all of these components, geometries and/or arrangements are essential to the invention and thus should not be taken in their restrictive sense, i.e. should not be taken to limit the scope of the present invention. It is to be understood, as will be apparent to a person skilled in the art, that other suitable components and co-operations therein between, as well as other suitable geometrical configurations and arrangements may be used, as will be briefly explained hereinafter, without departing from the scope of the invention. In the following description, the same numerical references refer to similar elements.

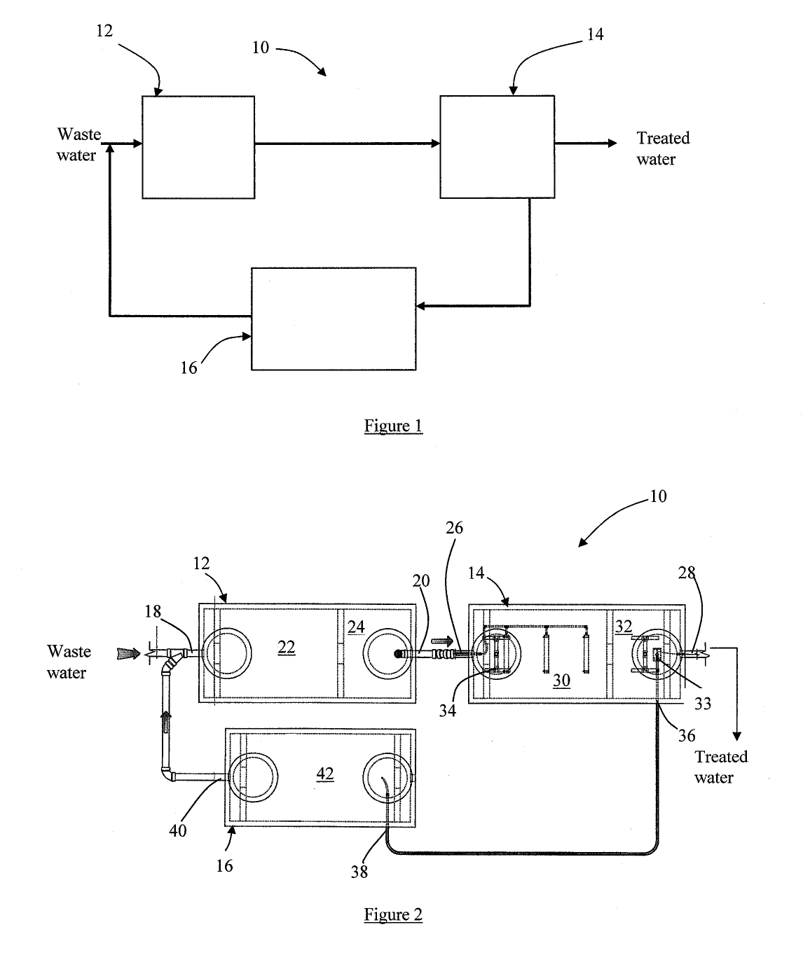

Referring initially to FIGS. 1 to 3, a system 10 for treating wastewater broadly comprises a septic tank 12 for separating solid matter from liquid matter in raw (untreated) wastewater, a reactor 14 (also known as a bioreactor) for treating the liquid matter from the septic tank 12 to lower its biochemical oxygen demand (BOD), and a de-oxygenating reactor 16, also known as a BIODO2 reactor, for lowering the dissolved oxygen levels of the wastewater from the bioreactor 14 to allow for denitrification in the septic tank 12.

In operation, liquid raw wastewater is separated from solid raw wastewater in the septic tank 12. The liquid raw wastewater flows to the bioreactor where it is biologically treated to lower its BOD. This treated wastewater then flows to the de-oxygenating reactor 16 where its levels of dissolved oxygen are reduced, and then re-cycled back to the septic tank 12 where denitrification takes place. The denitrified wastewater flows through the bioreactor 14 to remove or reduce excess BOD before being discharged from the system 10 at the bioreactor 14. By virtue of the system 10, the treated effluent being discharged from the bioreactor 14 has both low nitrate and BOD levels.

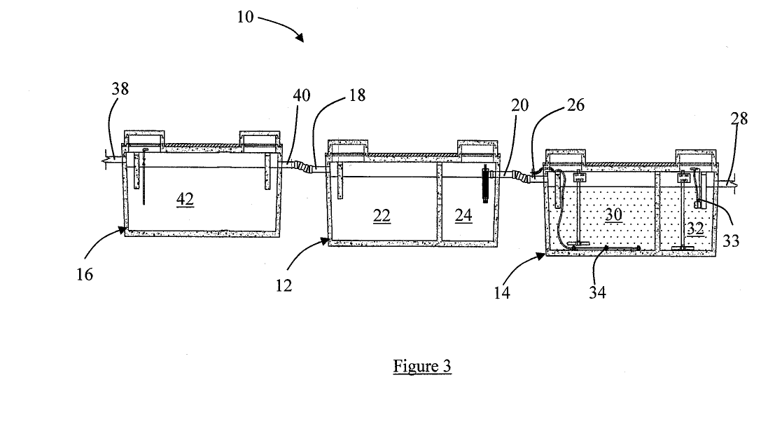

As best seen in FIGS. 2 and 3, the septic tank 12, which can be a domestic multi-chamber septic tank, has an inlet 18 through which raw wastewater is received and an outlet 20 for discharging aqueous liquid wastewater from the septic tank 12 to the bioreactor 14. Treated wastewater from the de-oxygenating reactor 16 is also received through the septic tank inlet 18 for being re-circulated through the septic tank 12 and the bioreactor 14, although it is also possible for it to be received through a separate inlet. As is known in the art, the septic tank 12 of this embodiment has first and second settling chambers 22, 24 in fluid communication with one another and in which the raw wastewater settles into a solid phase (sludge) and a liquid phase. The septic tank 12 effectively functions as a decanter. The liquid phase may separate further into an aqueous liquid phase and an oily liquid phase. The chambers 22, 24 are arranged such that the solid phase and oily liquid phase (if present) remain in the chambers 22, 24 whilst the aqueous liquid phase is discharged through the outlet 20 to the bioreactor 14. The septic tank 12 may equally have less or more chambers than the two described here and illustrated in FIGS. 2 and 3, as will be apparent to a person skilled in the art.

The bioreactor 14 of this embodiment is a multi-chamber reactor and is essentially a vessel in which the wastewater undergoes chemical processing by organisms present in the bioreactor. The reactor 14 has an inlet 26, which is in fluid connection with the outlet 20 of the septic tank 12 and a first outlet 28 through which the treated (remediated) wastewater can be discharged from the system 10. The bioreactor 14 comprises neighboring first and second chambers 30, 32 that are in fluid connection with each other. The first chamber 30 is aerated using conventional aerating apparatus 34 to create an aerobic environment for biological treatment of the wastewater with aerobic bacteria, whereas the second chamber 32 is deprived of air or oxygen to create an anoxic or anaerobic environment for biological treatment using anaerobic bacteria. The second chamber 32 of the reactor 14 has a re-circulating pump 33 for diverting a portion of the wastewater to the de-oxygenating reactor 16 via a second outlet 36 (FIG. 2).

Alternatively, the bioreactor 14 may have less or more chambers than the two described here and illustrated in FIGS. 2 and 3. If the bioreactor 14 has multiple chambers, these chambers may be any combination of aerobic, anoxic or anaerobic and can be individually and separately aerated and deprived of air or oxygen to promote the growth of both aerobic and anaerobic bacteria in the same chambers. Alternatively, the bioreactor 14 may comprise a single chamber which can be alternately aerobic, anoxic or anaerobic so that the wastewater being treated may be processed in “batches”. Alternatively, the single chamber may be designated as a fixed aerobic or anaerobic chamber.

The bacteria present in the chambers 30, 32 of the bioreactor 14 are preferably selected from the group consisting of nitrosomonas, nitrobacters, and the like. It will be appreciated that other bacteria and corresponding enzymes are equally suitable for use with the system 10. The bacteria may be naturally occurring in the wastewater or introduced therein from an outside source, depending on the particular applications of the system 10 and the type of wastewater which it is being used to treat, as will be apparent to a person skilled in the art. Typically, the bacteria in the chambers 30, 32 oxidize a portion of carbonaceous matter in the wastewater to carbon dioxide, which diffuses out of the wastewater in gaseous form. Also, nitrogen-containing compounds, such as ammonia, are converted to nitrites and nitrates. This results in a lowering of the BOD of the wastewater. Therefore, the wastewater, which passes to the de-oxygenating reactor 16 from the bioreactor 14, has low BOD and high levels of nitrates as a result of nitrification. This wastewater also still contains dissolved oxygen as a result of the aeration in the bioreactor 14 at levels higher than that preferred for denitrification to take place.

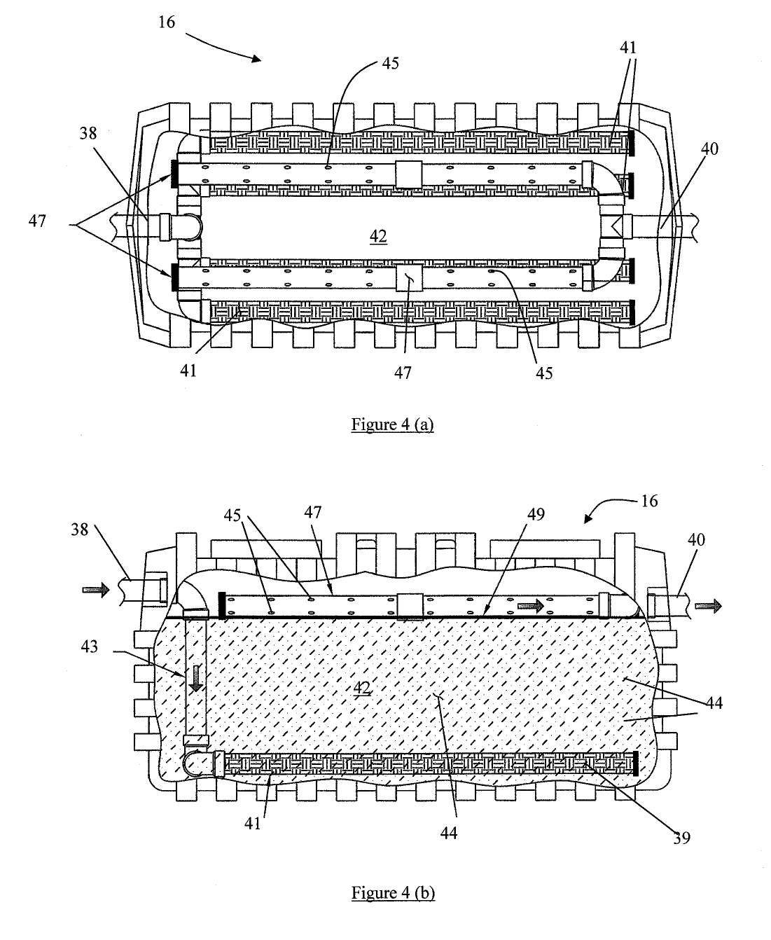

The de-oxygenating reactor 16 has an inlet 38 through which wastewater with low BOD flows from the bioreactor second outlet 36, and an outlet 40 connected to the inlet 18 of the septic tank 12. As best seen in FIGS. 4(a) and (b), the de-oxygenating reactor 16 comprises a chamber 42 having a substance with a demand on oxygen. In this embodiment, the substance is wood chips or wood shavings 44. There is a lower pipe 41 extending along a lower portion of the chamber 42 with inlet openings 39 through which wastewater can flow into the chamber 42. The lower pipe 41 or the inlet openings 39 may be provided by a filter, such as a geotextile, to avoid clogging of the openings 39 by the wood chips 44. The lower pipe 41 is connected to the de-oxygenating inlet 38 by a connecting pipe 43. As more wastewater is pumped, or flows, into the de-oxygenating chamber 42, wastewater released from the inlet openings 39 flows or percolates upwardly through the wood shavings 44 from the lower portion of the chamber 42 to an upper portion of the chamber 42. The wood shavings 44 have an oxygen demand and therefore have the effect of reducing or eliminating the amount of dissolved oxygen in the percolating wastewater. This wastewater, which will hereinafter be referred to as de-oxygenated wastewater, although it may still contain some dissolved oxygen, is forced through outlet openings 45 in an upper pipe 47 in the upper portion of the chamber 42. The de-oxygenated wastewater leaves the de-oxygenating reactor 16 via the de-oxygenating reactor outlet 40 connected to the upper pipe 47. A filter such as a water permeable geotextile 49 may be provided adjacent to, such as beneath or around, the upper pipe 47 to avoid clogging of the upper pipe 47 by the wood shavings 44.

The chamber 42 of the de-oxygenating reactor 16 is kept under anoxic conditions and wastewater flows into the chamber 42 through the inlet 38 and percolates through the wood shavings 44 to the outlet 40. In the chamber 42, partial or total de-oxygenating can occur as the wood shavings 44 have the effect of lowering the dissolved oxygen in the chamber 42. This de-oxygenated liquid is discharged from the chamber 42 via the outlet 40 and flows into the septic tank 12 for processing through the chambers 22, 24 of the septic tank 12 and the chambers 30, 32 of the bioreactor 14 before being discharged from the system 10 at the bioreactor 14. Denitrification of the wastewater may be initiated in the de-oxygenating reactor 16 or the septic tank 12, and is completed in the septic tank 12.

In this embodiment, there are four lower pipes 41 in the lower portion of the chamber and two upper pipes 47 in the upper portion of the chamber. However, it will be appreciated that the number and configuration of the pipes 41, 47 may differ from this. The connecting pipe 43 may be a PVC pipe having a four inch diameter. The lower pipe 41 may have a four inch diameter and be a French drain covered in a geotextile. Pores or a weave in the geotextile can provide the inlet openings 39 through which the wastewater can flow into the chamber 42. The upper pipe 47 may also be a PVC pipe having a four inch diameter and having walls in which the outlet openings 45 are formed. The de-oxygenating reactor 16 has a housing such as is known in the art. The housing can be made from, for example, plastic as shown in FIG. 4, or concrete, fibre glass or other known housing materials.

The wood shavings 44 have an oxygen demand and remove, reduce or strip the oxygen from the wastewater. In this embodiment, the wood shavings 44 are each about 5 to 10 cm³ in volume and are arranged in the chamber 42 in such a way that wastewater is able to permeate between them to the outlet 40 i.e. they do not act as a barrier to the through-flow of the wastewater. It will be appreciated that any other matter having an oxygen demand (i.e. being a source of BOD) can be used instead of wood shavings, such as organic carbon in a form which can support microorganisms, such as, for example, sawdust, wood chips, peat moss, straw, shredded seaweed or the like. The size of the BOD source can be selected according to its longevity. Sawdust will be used up quicker than wood shavings for example. The BOD source may be placed in porous containers with a suitable heavy inert filler material, such as sand, to keep the BOD source material immersed in the wastewater and to prevent it from floating.

It will be appreciated that the configuration of the de-oxygenating reactor 16 may differ from that described above and illustrated in FIGS. 1 to 4. What is important is that the de-oxygenating reactor 16 contains a substance having a demand on oxygen (i.e. a BOD source) for reducing the amount of dissolved oxygen in the wastewater passing through the de-oxygenating reactor 16. The exact way in which the wastewater is caused to contact this substance or to pass through the de-oxygenating reactor 16 may vary. For example, the de-oxygenating reactor inlet 38 may be positioned in the lower portion of the chamber 42 thereby eliminating the need for the connecting pipe 43. Also, the form of inlet and outlet openings 39, 45 through which the wastewater flows into and out of the chamber 42 may differ from that described and shown. Furthermore, although a water permeable geotextile 49 is used in the embodiment illustrated in FIG. 4, any other device or configuration to keep the wood shavings 44 in the chamber 42 and to prevent their migration into the inlet 38 or the outlet 40 can be adopted. For example, instead of the geotextile filter 49, a fine screen, web or other filtration means such as sand may be used.

Once the de-oxygenated wastewater flows back into the septic tank 12, denitrification takes place on the effluent from the de-oxygenating reactor 16 as well as on the raw wastewater as the conditions are suitable for denitrification: low dissolved oxygen as a result of the de-oxygenating reactor 16 effluent and high carbon content from the raw wastewater. Denitrification may also initiate in the de-oxygenating reactor 16. Therefore, this has the effect of reducing nitrate levels. Once this effluent reaches the bioreactor 14, it has very low nitrogen and nitrate levels but a high BOD level as a result of the BOD source of the de-oxygenating reactor 16. The excess BOD in the treated wastewater is removed in the bioreactor 14 to reduce the BOD level before part of the treated wastewater is discharged from the system 10.

Without wishing to be held to a particular theory, it is thought that the woodchips in the de-oxygenating reactor 16 are effective in removing dissolved oxygen from the effluent of the bioreactor to levels below 1 mg/L which is necessary for effective and efficient denitrification to occur. This is thought to be due to the oxygen demand of microorganisms supported by the carbon of the woodchips. Denitrification occurs in the septic tank 12 and may also occur in the de-oxygenating reactor 16. The resultant effluent therefore has low nitrate levels but a high BOD as a result of the BOD in the de-oxygenating reactor. By recycling the effluent from the de-oxygenating reactor through the septic tank 12 and the bioreactor 14, any excess BOD remaining in the treated effluent is removed resulting in an effluent with low nitrate levels and low BOD. The size of the septic tank 12, the bioreactor 14 and the de-oxygenating reactor 16 can be varied to allow for different retention times and meet specific goals for effluent discharge, as apparent to a person skilled in the art.

The de-oxygenating reactor 16 may also be used in conjunction with other reactors and in other wastewater systems to reduce or limit dissolved oxygen levels in wastewater for denitrification to take place.

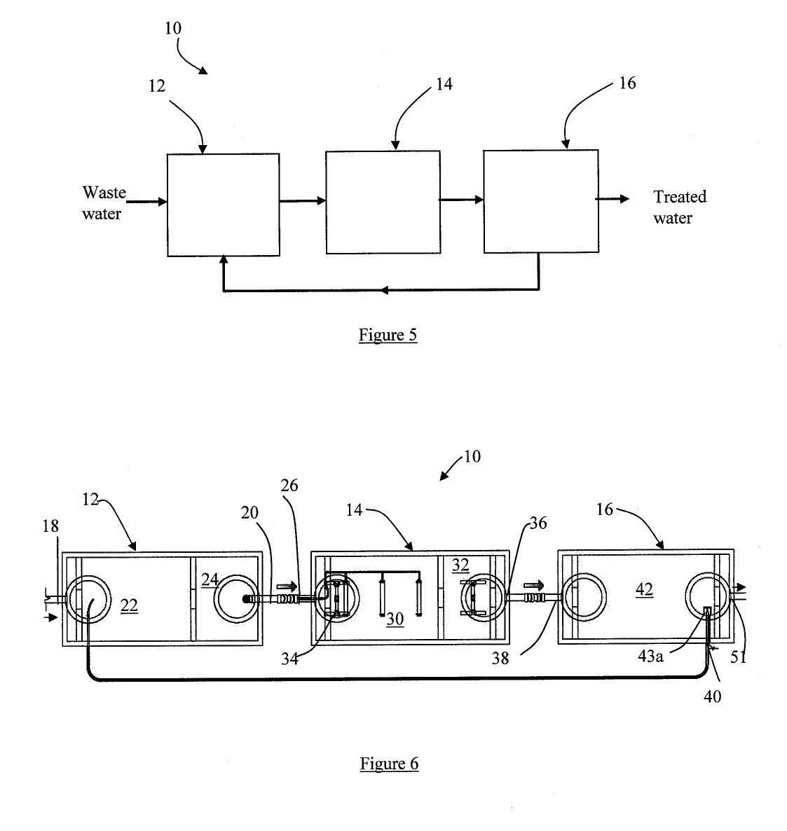

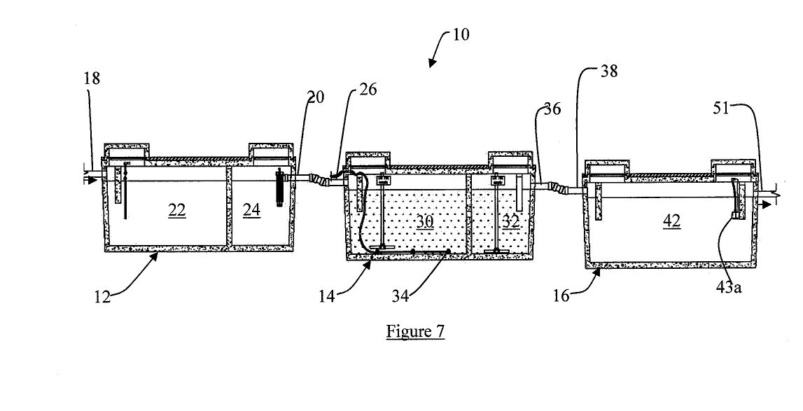

An alternative embodiment of the system 10 of FIGS. 1 to 4 is illustrated in FIGS. 5 to 7. The system of this embodiment differs from that of FIGS. 1 to 4 in that treated water is discharged from system 10 via a second outlet 51 in the de-oxygenating reactor 16 instead of the bioreactor 14. In effect, wastewater flows from the septic tank 12 to the bioreactor 14 to the de-oxygenating reactor 16 where a portion of the treated wastewater in the de-oxygenating reactor 16 is re-circulated back into the septic tank 12 via outlet 40 for de-nitrification to occur and a portion is discharged from the system via the second outlet 51. The de-oxygenating reactor 16 may include a pump 43a for diverting and re-circulating the portion of the effluent from the de-oxygenating tank 16 to the septic tank 12.

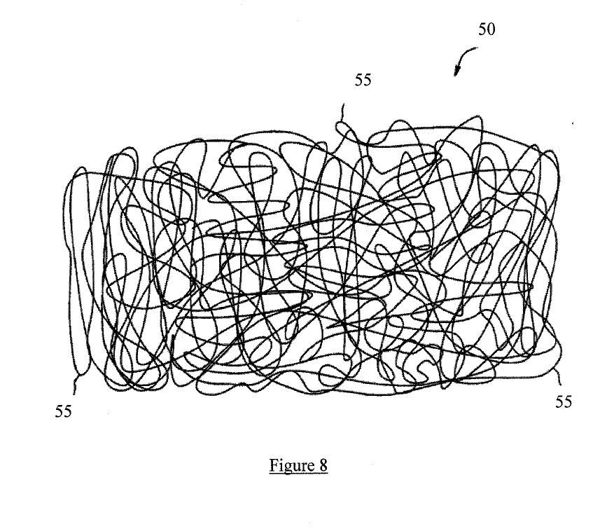

In a yet further embodiment of the present invention, the system 10 of either FIGS. 1 to 4, or 5 to 7 includes a bacteria growth device 50 (also referred to as a “Bionest™ device”), which is shown most clearly in FIG. 8. The Bionest™ device 50 has been described previously in WO 03/027031, the contents of which are incorporated herein in their entirety. The bacteria growth device 50 can be placed into any of the chambers of the septic tank 12 and the bioreactor 14 of any of the embodiments of the system 10 described above or illustrated in the drawings, without being supported by additional support means in the chambers. However, it is preferred to not use the bacteria growth device 50 in those chambers acting as a settling chamber.

The bacteria growth device 50 comprises at least one strip 55 having a surface area shaped and sized for receiving bacteria and for allowing attachment of said bacteria onto the surface area of the strip 55 so as to promote growth and proliferation of the attached bacteria. In an aerobic environment, the device 50 is used to promote the growth of aerobic bacteria, and in an anaerobic environment, the device 50 is used to promote the growth of anaerobic bacteria. By virtue of the bacteria growth device 50, the system 10 is provided with a large surface area for bacteria growth in a limited volume. As attached growth bacteria need a surface to attach to and to proliferate, the greater the surface area one can create for a given volume possible, the greater the efficiency of the treatment. Therefore, by virtue of the large surface area to volume ratio of the bacteria growth device 50, the efficiency of the nitrification and denitrification steps can be improved by increasing the amount of bacteria in the chambers of the reactor 14, septic tank 12, thereby providing a faster and more efficient treatment of the wastewater. The volume of the septic tank 12 or the bioreactor 14 can be reduced without compromising the output levels of the system. In effect, using the bacteria growth device 50 can increase the treatment capacity of the system 10.

As illustrated in FIG. 8, the bacteria growth device 50 comprises one or more strips 55 intertwined or gathered as a loose bundle and having a nest-like configuration. In the device 50, the one or more strips 55 cross or contact each other at points of intersection. However, it is important to note that intertwined as used herein does not mean fixed or bound: the one or more strips 55 are not fixed or bound to one another at the points of intersection. Therefore, niches or nests for three-dimensional biomass colonization are not created. In other words, the device 50 relates to bi-dimensional growth on the surface of the one or more strips 55 and by growth of bacteria on the surface is not meant three-dimensional colonization filling a niche.

By virtue of the loose and unbound nest-like configuration of the device 50, the overall shape and size of the device can be adapted according to the size of the chamber which it is being used in. In effect the strips will bundle up closer or further away from each other in order to fill the volume which they are occupying. The configuration of the strips 55 provides the device 50 with a certain amount of deformability and flexibility so that the device 50 can be made to fit into any shape or size of chambers of the bioreactor 14 and/or septic tank 12. In this way, the device 50 provides surfaces for the bacteria to attach and grown on throughout the entire volume of a chamber which maximizes the treatment effect of the wastewater.

This loose bundling configuration of the strips 55 without attachment also allows wastewater to circulate through the bacteria growth device 50 to contact the bacteria attached to the device for nitrification and/or denitrification of the wastewater in a controlled environment. In this regard, the bacteria growth device 50 is arranged so as to not substantially compress or to collapse or disintegrate over time and/or stop the flow of the fluid medium passing there through.

Also, this configuration avoids clogging of the device 50 as the strips can move relative to one another so that layers of bacteria can slough off. The strips 55 can flex and bend in the flow of water and any aeration that might be provided, thereby causing bacteria to slough off and not form a three-dimensional colony growth. This renders the device maintenance free in that it will not need to be removed from the chambers for cleaning.

It is to be understood that the Bionest™ device 50 may comprise one single strip 55 or a plurality of strips 55 bundled up together so as to obtain a desired nest-like configuration, such as the one illustrated in FIG. 8, or any other suitable geometrical configuration (whether one-, two-, or three-dimensional configuration; whether orderly or random spatial disposition; and/or whether tightly packed or loosely fitted; etc), depending on the particular applications for which the bacteria growth device 50 is intended and the particular liquid medium (e.g. wastewater) with which it is intended to interact. When the bacteria growth device 50 comprises a plurality of strips 55, these strips may be of various lengths and may be of different materials.

With regard to the geometrical and dimensional features of the strip 55 of the bacteria growth device 50, the strip 55 is as small and thin as possible while being structurally sound and rigid at the same time. The rigidity is, among other factors, provided by the nature of the material used as well as the cross-sectional size and shape of the strip 55. It is important not to manufacture the strip 55 of the device 50 too thin since it will become like a frail sheet that will collapse in on itself and will therefore not allow proper passage of the liquid medium through the device 50. Preferably, each strip 55 has a substantially rectangular cross-sectional area having a thickness of about 0.2 mm and a width of about 3.0 mm. Typically, for domestic applications, e.g. for a single-family household having three bedrooms, the nest-like configuration of the device 50 should occupy a volume of about 3 meters cube, for example. It should be understood that, according to the present invention, other suitable cross-sectional configurations may be used for the strip 55 of the bacteria growth device 50, as well as other volumetric dimensions, depending on the particular applications for which the bacteria growth device 50 is intended and the particular liquid medium with which it is intended to interact, as apparent to a person skilled in the art. However, it is worth mentioning that a structurally sound and very thin substantially rectangular cross-section is preferred in that it offers a greater surface area exposed for the amount of material used. Indeed, the greater the surface area of the strip 55, the greater the amount and rate of bacteria attachment and growth. Furthermore, the less material used for the strip 55 of the device 50, the less the resulting manufacturing costs, which is also advantageous.

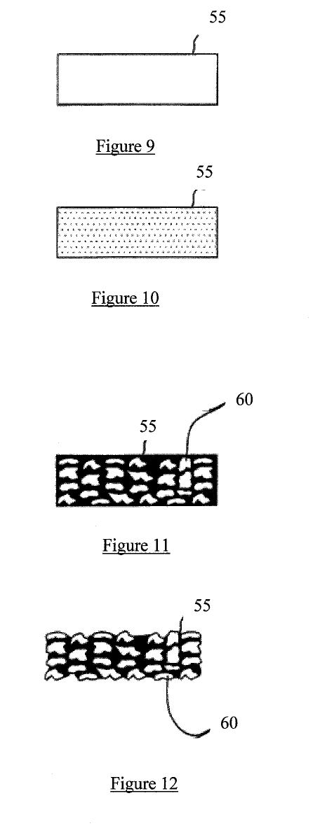

Each strip 55 (FIG. 9) is preferably made of a non-toxic and non-biocidal material that will not be detrimental to the attachment, growth and proliferation of bacteria, unlike polyvinyl chloride for example. Preferably, each strip 55 is made of a non-biodegradable material which will not disintegrate with time and leach chemicals harmful to bacteria or which would discourage bacteria growth or attachment. Preferably, the material of each strip 55 is a polymeric material, which may be virgin or recycled. The material is preferably selected from the group consisting of high-density polyethylene, polypropylene or any other polymer or rubber from which a loosely bundled strip can be manufactured by heating, extruding, molding, milling, casting or by making in any other way.

The strips 55 of the device 50 are preferably made with a suitable and cost-effective manufacturing process selected from the group of milling, extrusion, molding, machining, casting, and the like. After being manufactured by an appropriate process, the strips 55 are preferably put into an irregular, nest-like form by putting them through a gear or spinning them or blowing them as they are being formed. This is mainly to prevent them from substantially touching together and compacting together, because, as mentioned above, it important that wastewater can flow through the device 50 without excessive restriction.

In operation, the shape, size and nature of the surface area of the device 50 enables a more rapid growth of the bacterial mass, even when the flow of the wastewater being treated is high, by favoring adhesion, attachment and growth of the bacteria onto the surfaces of the strip 55. Excess residue from bacterial action, which falls off the device 50, becomes a source of carbon for further biological processing of the wastewater and/or can be removed by appropriate devices such as vacuums (not shown) placed at the bottom of the septic tank 12 or the bioreactor 14. Alternatively, excess residue from bacterial action which falls off the bacteria growth device 50 can also be pumped out of the tank 12 or the bioreactor 14 after an extended period of time.

In other embodiments of the bacteria growth device 50, as illustrated in FIGS. 10 to 12, the peripheral surface of the strip 55 of the device 50 is surface treated to further increase the effective surface area of the strip 55 and thus increase the attachment and growth of the bacteria thereon. In the embodiment of FIG. 10, the strip 55 of FIG. 9, which is virgin or recycled polymer, has been plasma etched to increase its surface area (known as Bionest™ Plus). The plasma-etched strip 55 of FIG. 10 has superior adhesive qualities for bacteria than the strip 55 of FIG. 9. Plasma etching is achieved using Plasma Etch Technology known in the art, and essentially uses a gas in a vacuum with a high frequency RF or microwave. The surface of any polymer can thus be appropriately etched to create a much larger effective surface area for the bacteria to attach thereto. This preferably includes all synthetic media that are presently being used to support bacteria growth, as will be apparent to a person skilled in the art.

FIGS. 11 and 12 illustrate another embodiment of the strip 55 of FIG. 9 in which the strip 55 is made of polymeric material blended with a porous material 60, such as zeolite. FIG. 11 illustrates this strip prior to its final processing, and FIG. 12 illustrates the strip 55 after final processing. The final processing can include plasma etching or machining to expose the porous material (known as Bionest™ Ultra). This provides an improved attachment surface for bacteria by increasing the effective surface area of the finished strip 55. Instead of plasma etching or machining, any other technique may be used to expose the porous material.

Preferably, the porous material 60 of the strips of FIGS. 11 and 12 are uniformly blended with the polymer before the manufacturing phase of the strip 55 such that the porous material lies just below the surface of the strip 55 once manufactured. As discussed earlier, the strip may be formed by molding, casting, machining, extruding and/or formed by any other suitable manufacturing process in which heat may be generated. Therefore, it will be appreciated that any inert porous material that is suitably heat resistant may be used for the strip 55 of the device 50. Furthermore, as can be easily understood by a person skilled in the art, the porous material 60 should not have holes or openings that are so big that the polymer will impregnate the openings. Preferably, the porous material 60 is selected from the group consisting of zeolite, activated carbon, porous stone/rock, and the like.

From another aspect, there is provided a method for treating wastewater, the method comprising: a) separating solid and liquid matter from raw wastewater in a septic tank; b) biologically treating the liquid matter in a bioreactor to lower biochemical oxygen demand levels of the liquid matter; c) treating the biologically treated liquid matter in a de-oxygenating reactor to reduce levels of dissolved oxygen to allow for denitrification to occur; and d) re-cycling at least a portion of the biologically treated liquid matter from the de-oxygenating reactor through the septic tank and the bioreactor before discharging from the system. In one embodiment, all of the treated wastewater from the de-oxygenating reactor is re-cycled through the septic tank and is discharged from the bioreactor. In another embodiment, one portion of the treated wastewater from the de-oxygenating reactor is re-cycled through the septic tank, and another portion of the treated wastewater is discharged from the de-oxygenating reactor. In both embodiments, treating the biologically treated liquid matter in the de-oxygenating reactor to reduce levels of dissolved oxygen comprises contacting the biologically treated liquid matter with woodchips, or any other substance having an oxygen demand.

### Examples

### Example 1

A wastewater treatment system 10 according to the first embodiment of the system illustrated in FIG. 1 was run continuously from May 28, 2008 to Sep. 5, 2008. The system included a septic tank 12, a bioreactor 14 and a de-oxygenation reactor 16, according to FIGS. 1 to 4. The bioreactor 14 contained a Bionest™ device 50 in both chambers 30, 32. Maintenance of the system was not required during the test period and the system was not required to be stopped at any time for draining the sludge or removing the Bionest™ device for cleaning. Treated water was discharged from the bioreactor 14 and was sampled at the time intervals indicated in Table 1. The sampled treated water was evaluated for dissolved oxygen (DO), nitrate levels, biological oxygen demand (BOD), total suspended solids (TSS) and total Kjeldahl nitrogen (TKN) according to defined tests: APHA Std. Meth. 18^{th} Edition for BOD; SM2540 D for TSS; Technicon calorimeter for TKN and Ionic Chromatography for Nitrates. The dissolved oxygen was measured by a dissolved oxygen meter (Oakton DO 110). The results are presented in Table 1. The results are far superior to current existing standards.

TABLE 1
DO, nitrate, BOD, TSS and TKN levels discharged from the Bioreactor

| | Effluent from bioreactor | | | | |
|---|---|---|---|---|---|
| | | Nitrates | BOD | TSS | TKN |
| Date of sampling | DO (mg/L) | (mg/L) | (mg/L) | (mg/L) | (mg/L) |
| Jun. 4, 2008 | 3.79 | 8.51 | 3 | 3 | 1.29 |
| Jun. 18, 2008 | 3.2 | 8.08 | 10 | 3 | 2.53 |
| Jun. 25, 2008 | 4.31 | 5.96 | 5 | 3 | 1.31 |
| Jul. 2, 2008 | 4.13 | 4.33 | 10 | 3 | 1.6 |
| Aug. 13, 2008 | 4.1 | 4.24 | 3 | 3 | 1.07 |

Table 2 shows pH and dissolved oxygen levels of the effluent from the bioreactor 14 compared to the de-oxygenating reactor 16. As can be seen, the pH of the effluent from both the bioreactor and the de-oxygenating reactor do not vary substantially from one sampling day to the next. Also, the pH levels fall within the internationally acceptable pH range of 6 to 9. Furthermore, it will be noted that the dissolved oxygen levels are high in the effluent from the bioreactor but are significantly lower in the effluent from the de-oxygenating reactor showing the effectiveness of the de-oxygenating reactor in reducing or eliminating dissolved oxygen.

TABLE 2
Bioreactor and de-oxygenating reactor effluent properties

| | pH | | Dissolved oxygen (mg/L) | |
|---|---|---|---|---|
| | Effluent | Effluent from | Effluent | Effluent from |
| Sampling | from | de-oxygenating | from | de-oxygenating |
| days | Bioreactor | reactor | Bioreactor | reactor |
| 1 | 6.4 | 6.53 | 4 | 0.4 |
| 2 | 6.58 | 6.64 | 4.22 | 0.25 |
| 3 | 6.77 | 6.73 | 3.43 | 0.25 |
| 4 | 6.6 | 6.7 | 3.8 | 0.25 |
| 5 | 6.6 | 6.6 | 3.3 | 0.25 |
| 6 | n.s. | n.s. | n.s. | n.s. |
| 7 | 6.58 | 6.81 | 4.37 | 0.06 |
| 8 | 6.47 | 6.71 | 3.91 | 0.1 |
| 9 | 6.4 | 6.77 | 3.56 | 0.06 |
| 10 | 6.29 | 6.59 | 4.23 | 0.31 |
| 11 | n.s. | n.s. | 3.82 | 0.31 |
| 12 | n.s. | n.s. | 3.71 | 0.29 |
| 13 | 5.95 | 6.37 | 4.57 | 0.39 |
| 14 | n.s. | n.s. | n.s. | n.s. |
| 15 | n.s. | n.s. | 3.3 | 0.06 |
| 16 | n.s. | n.s. | n.s. | n.s. |
| 17 | n.s. | n.s. | n.s. | n.s. |
| 18 | n.s. | n.s. | 3.77 | 0.21 |
| 19 | n.s. | n.s. | 4.02 | 0.32 |
| 20 | n.s. | n.s. | 4.41 | 0.47 |
| 21 | n.s. | n.s. | 2.03 | 0.38 |
| 22 | n.s. | n.s. | 2.42 | 0.37 |
| 23 | n.s. | n.s. | 3.44 | 0.31 |
| 24 | n.s. | n.s. | n.s. | n.s. |
| 25 | n.s. | n.s. | 3.21 | 0.1 |
| 26 | n.s. | n.s. | 3 | 0.15 |
| 27 | n.s. | n.s. | 2.08 | 0.29 |

n.s. = not sampled

### Example 2

A wastewater treatment system 10 according to the second embodiment of the system illustrated in FIG. 5 was run continuously from Jul. 20, 2007 to May 27, 2008. The system included a septic tank 12, a bioreactor 14 and a de-oxygenation reactor 16 according to FIGS. 5 to 7. The bioreactor 14 contained a Bionest™ device 50 in both chambers 30, 32. Maintenance of the system was not required during the test period and the system was not required to be stopped at any time for draining the sludge or removing the Bionest™ device for cleaning. Treated water was discharged from the de-oxygenation reactor 16 and was sampled at the time intervals indicated in Table 3. The sampled treated water was evaluated for dissolved oxygen (DO), nitrate levels, biological oxygen demand (BOD), total suspended solids (TSS) and total Kjeldahl nitrogen (TKN) according to defined tests: APHA Std. Meth. 18^{th} Edition for BOD; SM2540 D for TSS; Technicon calorimeter for TKN and Ionic Chromatography for Nitrates. The dissolved oxygen was measured by a dissolved oxygen meter (Oakton DO 110). The results are presented in Table 3. These results are far superior to current existing standards.

TABLE 3
DO, nitrate, BOD, TSS and TKN levels discharged from the de-
oxygenating reactor

| | Effluent from the de-oxygenating reactor | | | | |
|---|---|---|---|---|---|
| Date of | DO | Nitrates | BOD | TSS | TKN |
| sampling | (mg/L) | (mg/L) | (mg/L) | (mg/L) | (mg/L) |
| Jan. 23, 2008 | 0.6 | 0.41 | 3 | 3 | 1.47 |
| Feb. 20, 2008 | 0.82 | 0.98 | not | not sampled | 1.49 |
| | | | sampled | | |
| Apr. 2, 2008 | 0.75 | 1.6 | 3 | not sampled | 1.5 |
| Apr. 30, 2008 | 0.17 | 0.1 | 3 | 3 | 1.68 |
| May 7, 2008 | not sampled | 0.1 | 3 | 3 | 2.6 |

### Example 3

### Comparative Examples

The following examples are comparative examples of a system including the bacteria growth device 50 as described herein but not including the de-oxygenating reactor 16 of the present invention. The examples are included to illustrate the wide range of applicability of the present invention and are not intended to limit the scope of the present invention. Modifications and variations can be made therein without departing from the spirit and scope of the invention. Although any method and material similar or equivalent to those described herein can be used in the practice for testing, the preferred methods and materials are described.

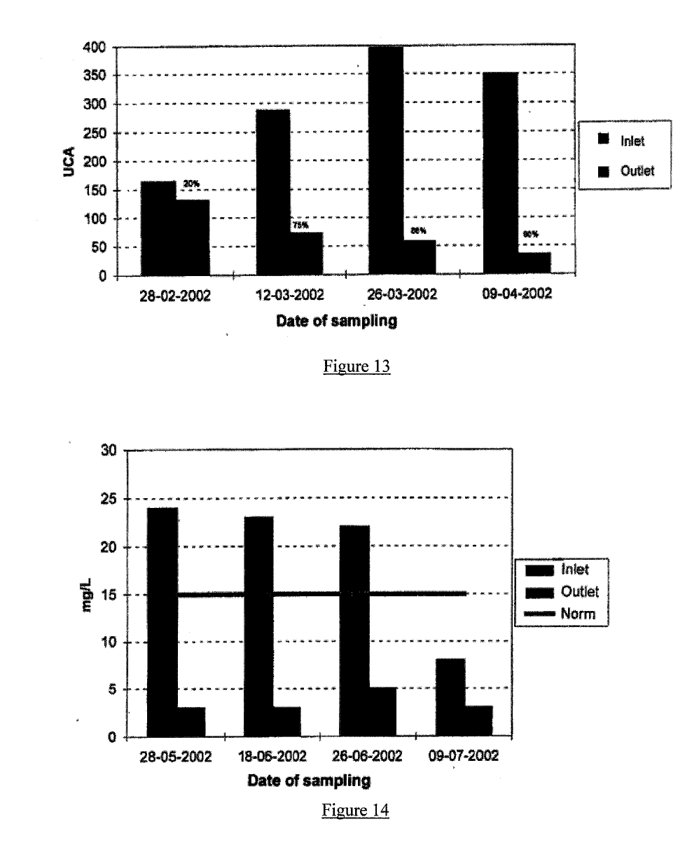

The following are the results of the analysis of various parameters of wastewater at the bioreactor inlet 26 and at the outlet 28 of a system including bacteria growth devices 50, but excluding the de-oxygenating reactor 16. FIG. 13 illustrates the apparent color of the water measured at the inlet and the outlet of the bioreactor 14. FIG. 14 illustrates levels of suspended solids at the inlet and the outlet of the bioreactor 14. These results are tabulated in Table 4.

TABLE 4
Levels of suspended solids measured at the
inlet and the outlet of the bioreactor

| | Date of sampling | | | |
|---|---|---|---|---|
| | 28 May 2002 | 18 Jun. 2002 | 26 Jun. 2002 | 09 Jul. 2002 |
| Levels of | 24 | 23 | 22 | 8 |
| suspended | | | | |
| solids at | | | | |
| Inlet* (mg/L) | | | | |
| Levels of | <3 | <3 | 5 | <3 |
| suspended | | | | |
| solids at | | | | |
| Outlet (mg/L) | | | | |

*after multiple recirculation back to the septic tank

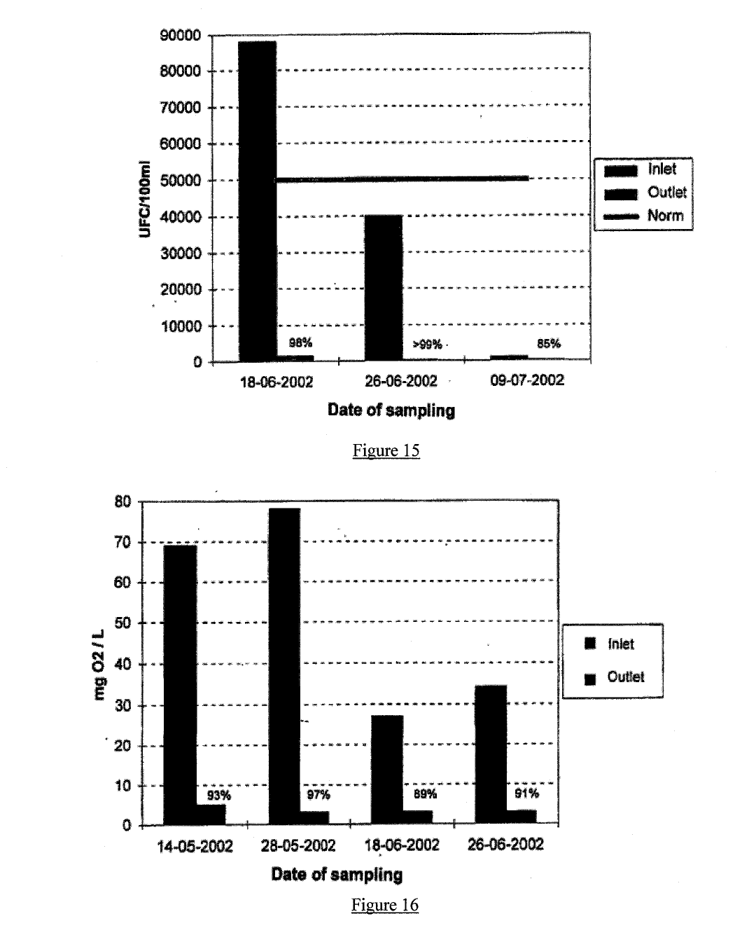

FIG. 15 illustrates levels of stercoraceous coliforms measured at the inlet and the outlet of the bioreactor 14 and these levels are tabulated in Table 5.

TABLE 5
Levels of stercoraceous coliforms measured at
the inlet and the outlet of the bioreactor

| | Date of sampling | | |
|---|---|---|---|
| | 18 Jun. 2002 | 26 Jun. 2002 | 09 Jul. 2002 |
| Levels of stercoraceous | 88000 | 40000 | 1000 |
| coliforms at Inlet* | | | |
| (UFC/100 mL) | | | |
| Levels of stercoraceous | 1400 | 180 | 150 |
| coliforms at Outlet | | | |
| (UFC/100 mL) | | | |

*after multiple recirculation back to the septic tank

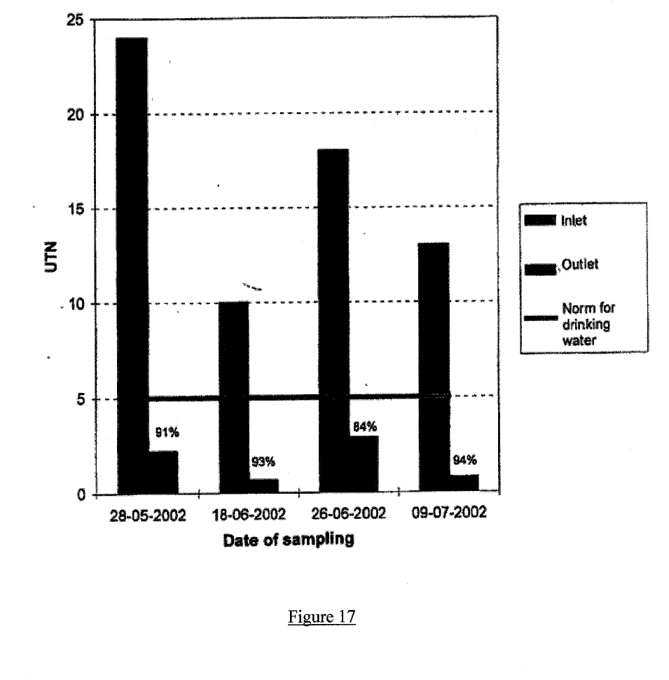

FIG. 16 illustrates the BOD levels measured at the inlet and the outlet of the bioreactor and these measurements are tabulated in Table 6.

TABLE 6
Levels of BOD measured at the inlet
and the outlet of the bioreactor

| | Date of sampling | | | |
|---|---|---|---|---|
| | 14 May 2002 | 28 May 2002 | 18 Jun. 2002 | 26 Jun. 2002 |
| BOD 5 days at | 69 | 78 | 27 | 34 |
| Inlet* | | | | |
| (mg O₂/L) | | | | |
| BOD 5 days at | 5 | <3 | <3 | <3 |
| Outlet | | | | |
| (mg O₂/L) | | | | |

*after multiple recirculation back to the septic tank

FIG. 17 illustrates the turbidity of the effluent measured at the inlet and the outlet of the bioreactor. Table 7 tabulates these measurements.

TABLE 7
Turbidity measured at the inlet and the outlet of the bioreactor

| | Date of sampling | | | |
|---|---|---|---|---|
| | 28 May 2002 | 18 Jun. 2002 | 26 Jun. 2002 | 09 Jul. 2002 |
| Turbidity at | 24 | 10 | 18 | 13 |
| Inlet* (NTU) | | | | |
| Turbidity at | 2.2 | 0.7 | 2.9 | 0.8 |
| Outlet (NTU) | | | | |

*after multiple recirculation back to the septic tank

A summary of the various parameters measured during five months of winter are presented in Table 8.

TABLE 8
Summary of various parameters analyzed during winter five months
Performance of the system during winter five months after installation

| | |
|---|---|
| Apparent color | 90% |
| Turbidity | 98% |
| Suspended solids | >99% |
| BOD 5 days | 99% |
| Stercoraceous coliforms | >99% |
| Total coliforms | >99% |
| Total Kjeldahl Nitrogen | 71% |
| Total phosphorus | 34% |

A comparative overview of the results obtained and the norms required is presented in Table 9.

TABLE 9
Comparative overview of the results
obtained and the norms required

| | Result | Norm |
|---|---|---|
| Ammonia Nitrogen (mg/L) | 0.24 | |
| Total Kjeldahl nitrogen (mg/L) | 1.12 | |
| Stercoraceous coliforms | 150 | 50000 |
| (UFC/100 mL) | | |
| Apparent color (UCA) | 23.7 | |
| Carbonaceous Oxygen Demand | 25 | |
| (COD) (mg/L) | | |
| Suspended solids (mg/L) | <3 | 15 |
| Total Phosphorus (mg/L) | 3.02 | |
| Turbidity (NTU) | 0.8 | 5 (for drinking |
| | | water) |
| BOD 5C (mg/L) | <3 | 15 |
| Nitrites/Nitrates (mg/L) | 5.57 | |

Table 9 indicates that the water treated by a portion of the system of the present invention, not including the de-oxygenating reactor 16, presents a much greater quality than that of most government standards. Furthermore, a very favorable turbidity may be achieved, in that it is inferior to that of drinking water. Moreover, there is a remarkable absence of coliforms in the water treated with the present invention: 300 times less than that of the required norm. Therefore, as demonstrated from the results herein, the water leaving the reactor 14 is of exceptional quality enabling its reuse after minor disinfection, namely for residential needs (such as: showers, pools, washing and irrigation) or its rejection into water courses without adverse effect for the fauna and the flora.

As may now be appreciated, the system of the present invention including the de-oxygenating reactor 16 and the method of the present invention provides a substantial improvement over these results by removing more nitrates from the treated water. Indeed, the system excluding the de-oxygenating reactor 16 is capable of purifying water at an exceptional rate of 95% and more, as shown hereinabove.

The present invention may be embodied in other specific forms without departing from its essential attributes as defined in the appended claims and other statements of invention herein. For example, instead of a septic tank 12, any other suitable apparatus can be used which can receive wastewater and where denitrification of the received wastewater can occur. Although the septic tank 12 has been described as removing the solids from wastewater, solids removal can occur at a step before or after the septic tank using suitable apparatus such as a screen, a filter, a screw or any other type of press, and the like, as apparent to a person skilled in the art. Instead of the bioreactor 14 described herein, any other apparatus suitable for treating wastewater to lower its Biochemical Oxygen Demand (BOD) can be used. Instead of the de-oxygenating reactor 16 described herein, any other apparatus suitable for lowering the dissolved oxygen in wastewater can be used. The septic tank 12, the bioreactor 14 and the de-oxygenating reactor 16 can be connected in any way other than as illustrated or described herein. It will be appreciated that existing water treatment systems can be retrofitted with the de-oxygenating apparatus 16 of the present invention to achieve treated wastewater having a low BOD and low levels of nitrates.

1. A system for treating wastewater, the system including: a septic tank for separating solid matter from liquid matter in raw wastewater; a bioreactor for receiving and biologically treating the liquid raw wastewater from the septic tank to lower its biochemical oxygen demand; and a de-oxygenating reactor for receiving and further treating the biologically treated wastewater from the bioreactor to reduce dissolved oxygen levels in the biologically treated wastewater; wherein the system is arranged so that at least a portion of the wastewater treated in the de-oxygenating reactor flows back into the septic tank and the bioreactor before being discharged from the system.

2. A system according to claim 1, wherein the system is arranged such that all of the treated wastewater from the de-oxygenating reactor flows into the septic tank and the treated wastewater is discharged from the system via the bioreactor.

3. A system according to claim 1, wherein one portion of the treated wastewater flows back into the septic tank from the de-oxygenating reactor and another portion of the treated wastewater is discharged from the system via the de-oxygenating reactor.

4. A system according to claim 1, wherein the de-oxygenating reactor includes a substance having an oxygen demand to lower the levels of dissolved oxygen in the wastewater contained therein.

5. A system according to claim 4, wherein the substance can support aerobic microorganisms.

6. A system according to claim 5, wherein the substance is selected from the group of organic carbon, wood, woodchips, sawdust, peat moss, straw, and seaweed.

7. A system according to claim 1, wherein the de-oxygenating reactor contains an inlet for receiving the biologically treated wastewater from the bioreactor and an outlet for re-circulating the treated wastewater to the septic tank, the substance being positioned between the inlet and the outlet such that wastewater flowing from the inlet to the outlet will contact the substance.

8. A system according to claim 7, wherein the outlet is positioned above the inlet such that the treated wastewater must percolate through the substance between the inlet and the outlet before being discharged from the de-oxygenating reactor.

9. A system according to claim 7, wherein the de-oxygenating reactor includes a filter to avoid clogging of the inlet or the outlet.

10. A system according to claim 9, wherein the filter is a geotextile.

11. A system according to claim 7, wherein either one or both of the inlet and the outlet comprise an elongate member having openings formed therein.

12. A system according to claim 1, further comprising an unsupported bacteria growth device in the septic tank or the bioreactor, the unsupported bacteria growth device comprising at least one strip loosely bundled up in an unbound, nest-like configuration, the strip having surfaces for bacteria to attach and grow on.

13. An apparatus for use in a wastewater treatment system, the apparatus having a chamber for receiving wastewater to be treated, the chamber including a substance having an oxygen demand to reduce the amount of oxygen dissolved in the wastewater to allow denitrification of the wastewater to occur.

14. An apparatus according to claim 13, wherein the substance can support aerobic microorganisms.

15. An apparatus according to claim 14, wherein the substance is selected from the group of organic carbon, wood, woodchips, sawdust, peat moss, straw, and seaweed.

16. An apparatus according to claim 13, further comprising an inlet for receiving the wastewater and an outlet for discharging the treated wastewater, the substance being positioned between the inlet and the outlet such that wastewater flowing from the inlet to the outlet will contact the substance.

17. An apparatus according to claim 16, wherein the outlet is positioned above the inlet such that the wastewater must percolate through the substance between the inlet and the outlet before being discharged from the apparatus.

18. An apparatus according to claim 16, further comprising a filter to avoid clogging of the inlet or the outlet.

19. An apparatus according to claim 18, wherein the filter is a geotextile.

20. An apparatus according to claim 16, wherein either one or both of the inlet and the outlet comprise an elongate member having openings formed therein.

21. An apparatus according to claim 16, wherein the outlet is in fluid communication with a second chamber where denitrification takes place.

22. An apparatus according to claim 21, wherein the second chamber is in fluid communication with a third chamber for lowering biochemical oxygen demand levels.

23. An apparatus according to claim 13, further comprising an unsupported bacteria growth device, the unsupported bacteria growth device comprising at least one strip loosely bundled up in an unbound, nest-like configuration, the strip having surfaces for bacteria to attach and grow on.

24. (canceled)

25. A method for treating wastewater, the method comprising:
a) separating solid and liquid matter from raw wastewater in a septic tank; b) biologically treating the liquid matter in a bioreactor to lower biochemical oxygen demand levels of the liquid matter; c) treating the biologically treated liquid matter in a de-oxygenating reactor to reduce levels of dissolved oxygen to allow for denitrification-to occur; and d) re-cycling at least a portion of the biologically treated liquid matter from the de-oxygenating reactor through the septic tank and the bioreactor before discharging from the system.

26. A method according to claim 25, wherein all of the treated wastewater from the de- oxygenating reactor is re-cycled through the septic tank and is discharged from the bioreactor.

27. A method according to claim 25, wherein one portion of the treated wastewater from the de-oxygenating reactor is re-cycled through the septic tank, and another portion of the treated wastewater is discharged from the de-oxygenating reactor.

28. A method according to claim 27, further comprising pumping the portion of the treated wastewater from the de-oxygenating reactor to the septic tank.

29. A method according to claim 25, wherein treating the biologically treated liquid matter in the de-oxygenating reactor to reduce levels of dissolved oxygen comprises contacting the biologically treated liquid matter with a substance having an oxygen demand.

30. A method according to claim 29, wherein the substance comprises woodchips and the biologically treated liquid matter flows through the woodchips.
